(19) United States
(12) Patent Application Publication
(10) Pub. No.: US 2025/0226431 A1
(43) Pub. Date: Jul. 10, 2025

(54) ULTRAVIOLET-CURABLE GLUING REAGENT FOR ELECTRODE STACKING

(71) Applicant: GM GLOBAL TECHNOLOGY OPERATIONS LLC, DETROIT, MI (US)

(72) Inventors: Wai Ping Gloria Tam, Troy, MI (US); Fang Dai, Troy, MI (US); Nathaniel Hardin, Farmington Hills, MI (US); David F. Titmuss, Commerce Township, MI (US); Alex Carr, Royal Oak, MI (US); Aiden Kwak, Clinton Township, MI (US)

(21) Appl. No.: 18/403,950

(22) Filed: Jan. 4, 2024

(51) Int. Cl. H01M 10/04; C09J 11/06; C09J 11/08; H01M 50/204; H01M 50/249

(52) U.S. Cl. CPC H01M 10/0431; C09J 11/06; C09J 11/08; H01M 50/204; H01M 50/249; H01M 2220/20

(57) ABSTRACT

Aspects of the disclosure include ultraviolet-curable gluing reagents and methods of using the same for electrode stacking. An exemplary vehicle includes an electric motor and a battery pack electrically coupled to the electric motor. The battery pack includes a plurality of battery cells, each battery cell having an electrode stack. The electrode stack of each battery cell includes a plurality of battery foils separated by an insulated member in a stacked configuration that includes alternating battery foil and insulated member layers. The electrode stack of each battery cell further includes an ultraviolet-curable gluing reagent. The ultraviolet-curable gluing reagent is applied between the alternating battery foil and insulated member layers, thereby gluing the plurality of battery foils to the insulated member. The ultraviolet-curable gluing reagent includes a multifunctional acrylate crosslinking agent and an initiator.

### INTRODUCTION

The present disclosure relates to battery cell manufacturing, and particularly to an ultraviolet-curable gluing reagent for electrode stacking.

Manufacturing speed and product reliability are important factors in battery cell production. Many softly packaged lithium-ion batteries rely on an insulated member positioned between adjacent battery components. Typically, the insulating member takes the form of a continuous sheet of electrically insulative material that is folded over the battery components to form a stack. In one example, the electrically insulative material passes through a mechanism that creates alternating layers. The alternating layers are folded over and pressed against a battery electrode to form, in one example, a “z-fold stack”. Other systems may manipulate the structure to form a “jelly roll stack”.

Once a selected number of electrodes are separated and formed, the stack is removed, secured, and stored for transit. Given the nature of the stack, folds that are not fully secured may allow the electrode to slip or become misaligned. This misalignment may be exacerbated when the stacks are transported. Misalignment of the battery electrodes may have a detrimental effect on battery efficiency.

### SUMMARY

In one exemplary embodiment a vehicle includes an electric motor and a battery pack electrically coupled to the electric motor. The battery pack includes a plurality of battery cells, each battery cell having an electrode stack. The electrode stack of each battery cell includes a plurality of battery foils separated by an insulated member in a stacked configuration that includes an alternating battery foil and insulated member layers. The electrode stack of each battery cell further includes an ultraviolet-curable gluing reagent. The ultraviolet-curable gluing reagent is applied between the alternating battery foil and insulated member layers, thereby gluing the plurality of battery foils to the insulated member. The ultraviolet-curable gluing reagent includes a multifunctional acrylate crosslinking agent and an initiator.

In addition to one or more of the features described herein, in some embodiments, the multifunctional acrylate crosslinking agent includes a multi-dented alkyl acrylate.

In some embodiments, the multifunctional acrylate crosslinking agent includes a multibranched alkyl acrylate having N branches, wherein N is 1, 2, 3, or 4. In some embodiments, the multifunctional acrylate crosslinking agent includes at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

In some embodiments, the initiator includes a photoinitiator including at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

In some embodiments, the stacked configuration includes a z-fold stacked configuration having two or more electrode folds.

In some embodiments, the ultraviolet-curable gluing reagent is cured using an ultraviolent light source, thereby fixing the electrode stack.

In another exemplary embodiment an ultraviolet-curable gluing reagent includes a multifunctional acrylate crosslinking agent including a multi-dented alkyl acrylate. The multi-dented alkyl acrylate includes a multibranched alkyl acrylate having N branches. N is 1, 2, 3, or 4. The multi-dented alkyl acrylate further includes a photoinitiator at an initiator-to-monomer weight ratio of 0.05 weight percent to 10 weight percent.

In some embodiments, the multifunctional acrylate crosslinking agent includes at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

In some embodiments, the initiator includes a photoinitiator including at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

In some embodiments, the ultraviolet-curable gluing reagent further includes a binding additive. In some embodiments, the binding additive includes a polymer having an unsaturated structure. In some embodiments, the binding additive includes at least one of styrene butadiene (SBR) and silicone.

In yet another exemplary embodiment a manufacturing process for stacking electrodes can include forming an electrode stack including a plurality of battery foils separated by an insulated member in a stacked configuration that includes an alternating battery foil and insulated member layers. The method can include applying an ultraviolet-curable gluing reagent between the alternating battery foil and insulated member layers. The ultraviolet-curable gluing reagent can include a multifunctional acrylate crosslinking agent and an initiator. The method includes curing the ultraviolet-curable gluing reagent by exposing the ultraviolet-curable gluing reagent to an ultraviolet light source, thereby fixing the plurality of battery foils to the insulated member in the electrode stack.

In some embodiments, the multifunctional acrylate crosslinking agent includes a multi-dented alkyl acrylate.

In some embodiments, the multifunctional acrylate crosslinking agent includes a multibranched alkyl acrylate having N branches, wherein N is 1, 2, 3, or 4.

In some embodiments, the multifunctional acrylate crosslinking agent includes at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

In some embodiments, the initiator includes a photoinitiator including at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

In some embodiments, the stacked configuration includes a z-fold stacked configuration having two or more electrode folds.

In some embodiments, the ultraviolet-curable gluing reagent includes the multifunctional acrylate crosslinking agent and the initiator at an initiator-to-monomer weight ratio of 0.05 weight percent to 10 weight percent.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example battery stack in accordance with one or more embodiments;

FIG. 3A is an example single branch ethyl acrylate crosslinking agent in accordance with one or more embodiments;

FIG. 3B is an example double branch ethyl acrylate crosslinking agent in accordance with one or more embodiments;

FIG. 3C is an example triple branch ethyl acrylate crosslinking agent in accordance with one or more embodiments;

FIG. 3D is an example quadruple branch ethyl acrylate crosslinking agent in accordance with one or more embodiments;

FIG. 4 is an example system for z-stacking a battery stack in accordance with one or more embodiments;

FIG. 5A is an example application of an ultraviolet-curable gluing reagent to a foil support surface of an electrode stack in accordance with one or more embodiments;

FIG. 5B is another example application of an ultraviolet-curable gluing reagent to a foil support surface of an electrode stack in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Battery manufacturing, such as in the production of softly packaged lithium-ion batteries, involves the stacking of a number of electrically isolated electrodes. During this stacking process, the goal is to efficiently arrange multiple layers of electrode materials, separators, and other components to form a structurally sound and electrically functional stack. In many manufacturing processes, an insulated member is positioned between adjacent battery components to prevent short circuits and to ensure proper electrical isolation between the electrodes.

In one common approach, the insulated member takes the form of a continuous sheet of electrically insulative material. This material undergoes a process where alternating layers are created, and these layers are then folded over and pressed against a battery electrode, resulting in what is referred to as a “z-fold stack.” Alternatively, some systems manipulate the structure to form a “jelly roll stack.” In either case, these methods aim to create a compact and well-organized arrangement of battery components within the stack.

Unfortunately, common manufacturing techniques for electrode stacking result in electrode stacks that are susceptible to misalignment. The folding and pressing mechanisms are sensitive steps, and any lapses in securing the folds may lead to electrode slippage or misalignment. Misalignment occurs when an electrode shifts within the stack and can result in a loss in battery efficiency.

This disclosure introduces a new ultraviolet-curable gluing reagent for electrode stacking. Rather than relying solely on precise electrode and insulative sheet folding, the ultraviolet-curable gluing reagent described herein is used to glue the separator to the electrode during the stacking process. Advantageously, the reagent can be solidified by ultraviolet (UV) light from a liquid phase that is natively compatible with current electrode stacking manufacturing processes (e.g., the pre-cure liquid form allows for conventional cell fabrication process without modification). In some embodiments, the ultraviolet-curable gluing reagent includes a multifunctional acrylate crosslinking agent such as multi-dented alkyl acrylate, an initiator such as benzyl peroxide (BPO) or benzophenone, and an optional binding additive such as a polymer with an unsaturated structure (e.g., styrene butadiene (SBR), silicone, etc.) to adjust the curing conditions and to increase binding strength.

Leveraging ultraviolet-curable gluing reagent for electrode stacking in accordance with one or more embodiments offers several technical advantages over prior electrode stacking manufacturing processes. In short, battery stacks leveraging UV-curable gluing reagents as described herein can better withstand the rigors of production processes and subsequent transit without compromising their structural robustness and alignment. In other words, the result is a battery stack that can be produced with minimal impact on manufacturing speed while greatly improving product reliability relative to prior stacking processes. Other advantages are possible. For example, the UV-curable design allows for faster manufacturing, and the relatively fast gluing of the separator and electrodes can improve alignment by reducing the window of time for slippage. In addition, the UV-curable design is natively a non-contact curing method, preventing battery stack contamination. Moreover, component selection for the ultraviolet-curable gluing reagent is flexible for different active materials and compatible with a range of polymer based separators.

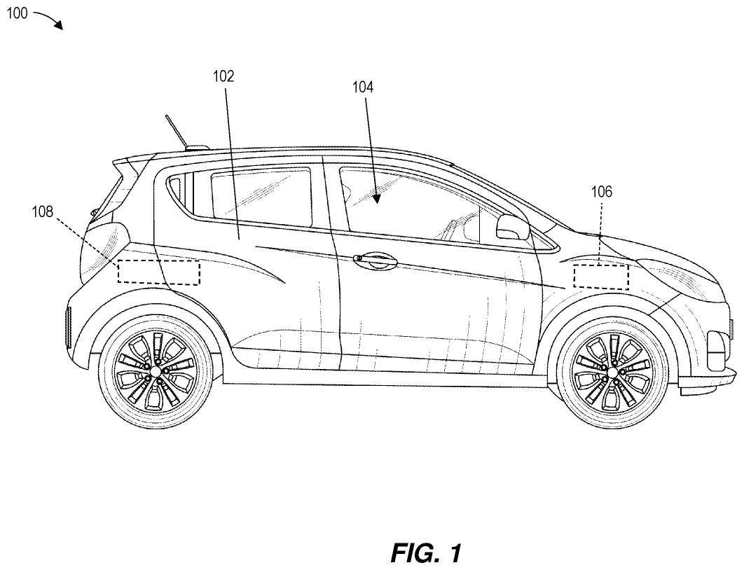

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

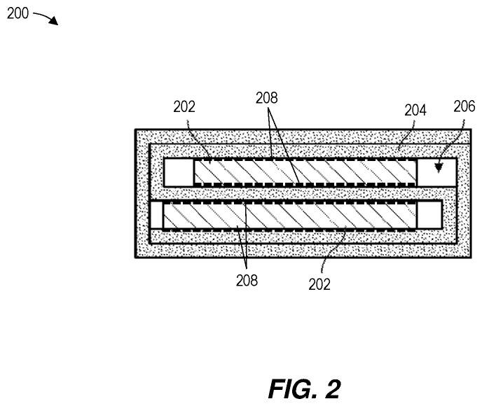

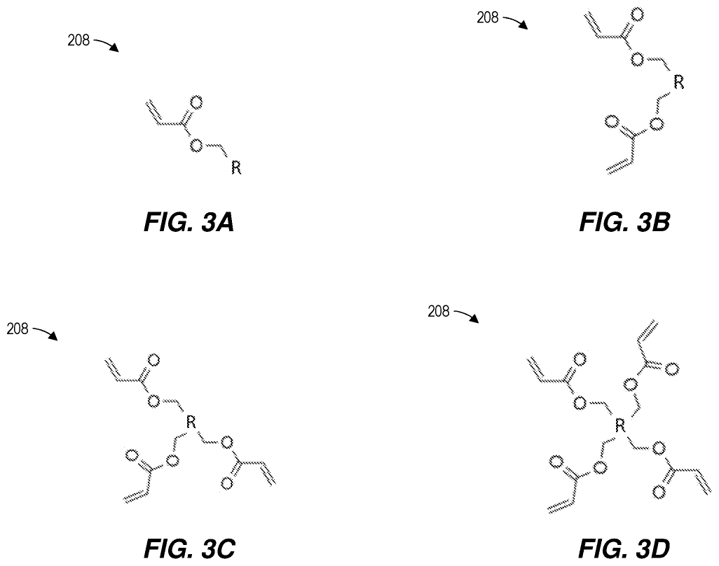

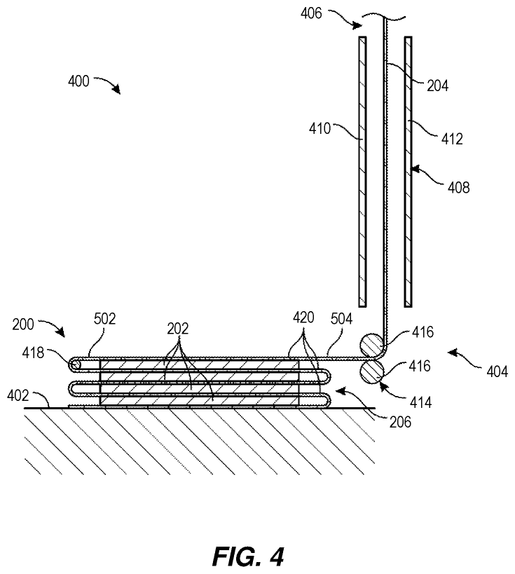

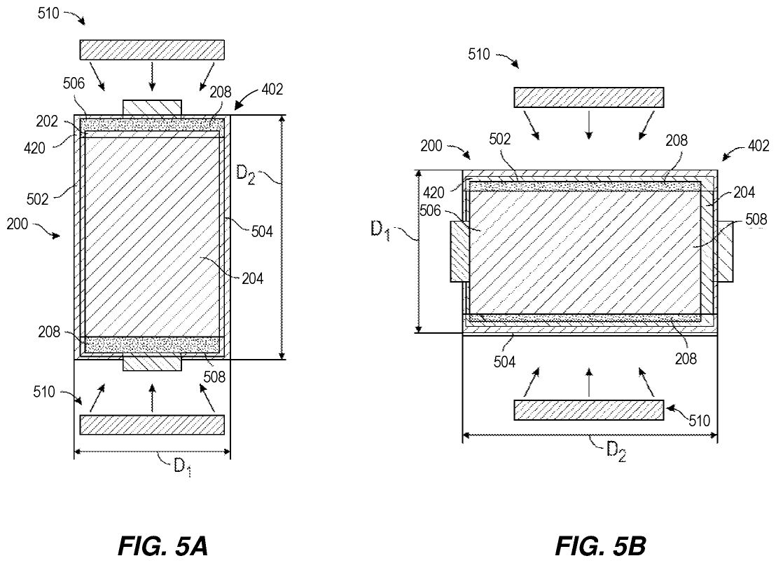

As will be detailed herein, the battery pack 108 includes one or more battery cells and/or battery pouches made from electrode stacks secured using an ultraviolet-curable gluing reagent. An example electrode stack bound via the ultraviolet-curable gluing reagent is shown in FIG. 2. Example compounds for the ultraviolet-curable gluing reagents are shown in FIGS. 3A, 3B, 3C, and 3D. An example manufacturing process for stacking electrodes using ultraviolet-curable gluing reagents is shown in FIG. 4. Example battery foil support surfaces including an amount of the ultraviolet-curable gluing reagents is shown in FIGS. 5A and 5B.

FIG. 2 illustrates an example battery stack 200 in accordance with one or more embodiments. The battery stack 200 can be incorporated as a component of a number of battery cells in a battery pack (e.g., the battery pack 108 in FIG. 1). As shown in FIG. 2, the battery stack 200 includes a plurality of battery foils 202 separated via an insulated member 204 in a so-called z-fold stack configuration having a number of electrode folds 206 (also referred to as electrode layers, or as foil layers or folds). It should be understood that, while a z-fold stack configuration is shown for convenience, other stacking arrangements are possible and all such configurations are within the contemplated scope of this disclosure. Moreover, while the particular z-fold stack configuration shown in FIG. 2 depicts two folds 206, it should be understood that the folding process can be continued to create a battery stack 200 having any number of folds 206.

As further shown in FIG. 2, the plurality of battery foils 202 are fixed to the insulated member 204 using an ultraviolet-curable gluing reagent 208 (shown via projection). In some embodiments, the ultraviolet-curable gluing reagent 208 is cured, thus gluing the battery foils 202 to the insulated member 204, using a UV light source (refer to FIGS. 5A and 5B). The ultraviolet-curable gluing reagent 208 is discussed in greater detail with respect to FIGS. 3A to 3D.

The battery foils 202 can be made of sheets or foils of conductive metal. For example, cathode battery foils can be made of aluminum foil, stainless steel, and/or titanium foil. Other materials are possible, such as, for example, semimetals (e.g., tin, graphite) and alloys of the metals and/or semimetals thereof. Anode battery foils are typically made of copper and/or copper foil, although other materials, such as a copper alloys, stainless steel, carbon foil, silicon foil, and silicon alloy foil are also possible. The insulated member 204 can include dielectric materials such as, for example, polyethylene (PE), polypropylene (PP), polyethylene terephthalate (PET), and composites thereof, although other dielectrics are within the contemplated scope of this disclosure. While not separately shown, in some embodiments, an active material is applied to the battery stack 200. The active material is not meant to be particularly limited, but can include, for example, various cathode or anode materials (depending on the requirements of a specific application), such as, for example, activated carbon powder, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), graphite, silicon, silicon-graphite composites, tin, tin oxide (SnO2), lithium titanate (Li4Ti5O12, LTO), sulfur and lithium-sulfur (Li—S) composites, lithium metal (Li), and/or lithium alloys such as lithium-antimony (Li—Sb), lithium-aluminum (Li—Al), and lithium-germanium (Li—Ge).

FIGS. 3A, 3B, 3C, and 3D illustrate examples of the ultraviolet-curable gluing reagent 208 in accordance with one or more embodiments. In some embodiments, the ultraviolet-curable gluing reagent 208 includes a multifunctional acrylate crosslinking agent, such as, for example, a multi-dented alkyl acrylate. As used here, a “multi-dented” alkyl acrylate refers to a multibranched alkyl acrylate having N branches. FIG. 3A depicts an ultraviolet-curable gluing reagent 208 having a single branch (e.g., N=1) ethyl acrylate crosslinking agent. While a single branch ethyl acrylate is shown for convenience, a single branch methyl acrylate, having only a single carbon between the oxygen and terminal group “R” (as well as other alkyl acrylates) are also possible and are within the contemplated scope of this disclosure. FIG. 3B depicts an ultraviolet-curable gluing reagent 208 having a double branch (e.g., N=2) diethyl acrylate crosslinking agent. Similarly, other double branch alkyl acrylates are possible and are within the contemplated scope of this disclosure. FIG. 3C depicts an ultraviolet-curable gluing reagent 208 having a triple branch (e.g., N=3) triethyl acrylate crosslinking agent. Similarly, other triple branch alkyl acrylates are possible and are within the contemplated scope of this disclosure. FIG. 3D depicts an ultraviolet-curable gluing reagent 208 having a quadruple branch (e.g., N=4) tetraethyl acrylate crosslinking agent. Similarly, other quadruple branch alkyl acrylates are possible and are within the contemplated scope of this disclosure.

In each of the configurations shown in FIGS. 3A, 3B, 3C, and 3D, the terminal group R can include a range of polymer and/or hydrocarbon chains. For example, the terminal group R can include a methyl group, an ethyl group (refer to FIG. 3A), an N-length hydrocarbon chain (e.g., a 6-carbon chain in a diacrylate hexane diol diacrylate configuration, etc.), a triethyl group (e.g., for a trimethylolpropane triacrylate configuration, etc.), a tetraethyl group (e.g., for a pentaerythritol tetraacrylate, etc.). Other acrylic monomers/crosslinkers, and multibranched monomers/crosslinkers, are possible and all such configurations are within the contemplated scope of this disclosure.

In some embodiments, the ultraviolet-curable gluing reagent 208 includes a mixture of the multifunctional acrylate crosslinking agent and an initiator (not separately shown). In some embodiments, the initiator is a photoinitiator to support the UV-curing of the ultraviolet-curable gluing reagent 208. The initiator can be selected from various type 1 and type 2 classes. As used herein, a “type 1” initiator refers to an initiator that makes primary radicals by splitting upon photon absorption. As used herein, a “type 2” initiator refers to an initiator that absorbs a photon then uses hydrogen from either a chemical or co initiator to make a secondary radical. Type 1 initiators include, for example, peroxides such as benzoyl peroxide (BPO) and tertbutyl peroxide, azo compounds such as azobisisobutyronitrile, phosphine oxides such as 2,4,6-trimethylbenzoyldiphenylphosphine oxide, and methyl benzoylformate. Type 2 initiators include, for example, benzophenone and thioxanthone. In some embodiments, the initiator is mixed with monomers (the multifunctional acrylate crosslinking agent) at an initiator-to-monomer weight ratio of from 0.05 wt % to 10 wt %. In some embodiments, the ultraviolet-curable gluing reagent 208 includes an optional binding additive, such as a polymer with an unsaturated structure, to adjust the curing conditions and to increase binding strength. Example binding additives include styrene butadiene (SBR) and silicone.

In some embodiments, after mixing the multifunctional acrylate crosslinking agent, initiator, and optional binding additive, the resulting ultraviolet-curable gluing reagent 208 is applied to a separator and/or foil surface for electrode stacking (refer to FIGS. 5A and 5B). The ultraviolet-curable gluing reagent 208 can be applied using any suitable process, such as, for example, via a syringe, reverse comb, etc. In some embodiments, the ultraviolet-curable gluing reagent 208 is then cured via UV irradiation using, for example, a UV source/box/spotlight, a UV laser, etc. Curing can take place after each folding step (that is, after the addition of each new foil and respective portion of the insulated member) and/or after completion of the respective electrode stack.

FIG. 4 illustrates an example system 400 for z-stacking a battery stack (e.g., the battery stack 200) in accordance with one or more embodiments. As shown in FIG. 4, the system 400 includes a stack table 402 and a z-fold arm 404 having an electrically insulated material feed system 406. In some embodiments, the z-fold arm 404 lays an amount of the insulated member 204 (itself made of electrically insulated material as discussed previously) onto the stack table 402 to form a battery stack 200 such as shown in FIG. 2. In some embodiments, the z-fold arm 404 includes an ultraviolet light guard 408 including a first guard member 410 and a second guard member 412 that shield the insulated member 204 from inadvertent (premature) exposure to UV light.

In some embodiments, the z-fold arm 404 includes a terminal end 414 having a pair of guide rollers 416 that shift portions of the insulated member 204 back and forth across stack table 402 to form the battery stack 200. In some embodiments, the guide rollers 416 pass a predetermined portion (length) of the insulated member 204 over a selectively shiftable fold guide 418 to create a series of electrode folds 206.

In some embodiments, each of the series of electrode folds 206 is z-shaped, creating a foil support surface 420 upon which is positioned a battery foil 202. A plurality of battery foils 202 and a plurality of battery support surfaces 420 thus form a consolidated battery stack 200 such as that shown in FIG. 2. At this point it should be reiterated again that the series of folds shown are merely illustrative and may take on other geometries.

Reference will now follow to FIG. 5A, with continued reference to FIG. 4, in describing one of the plurality of foil support surfaces 420 in a non-limiting example. Foil support surface 420 includes a first dimension D₁ defining a first axis and a second dimension D₂ defining a second axis that is substantially perpendicular to the first axis. In a non-limiting example, the first dimension D₁ is smaller than the second dimension D₂.

In some embodiments, foil support surface 420 includes a folded edge 502 that extends along the second axis and a pre-folded edge 504 that extends along the second axis. As used herein, the term “folded edge” describes an edge that has been folded over fold guide 418 and the term “pre-folded edge” describes an edge that has not yet been folded. As can be seen in FIG. 5A, dimension D₂ is defined between a first end 506 and a second end 508 of the foil support surface 420.

In some embodiments, a UV-based curing system, shown in the form of UV lights 510, are mounted relative to stack table 402 along the first axis. In some embodiments, an amount of ultraviolet-curable gluing reagent 208 is applied to foil support surface 420. In some embodiments, an amount of ultraviolet-curable gluing reagent 208 is applied across the first axis at first end 506 and second end 508. Once applied, z-fold arm 404 (refer to FIG. 4) is shifted to position a new layer of electrically insulated material (the next layer of the insulated member 204) over battery foil 202 creating a new foil support surface 420. At this point, the UV lights 510 may be illuminated to activate the portion of the ultraviolet-curable gluing reagent 208 applied to the respective foil support surface 420. In this manner, battery stack 200 includes a plurality of bonded layers that are more stable and less prone to shifting when being stored or transported.

Reference will now follow to FIG. 5B with continued reference to FIG. 4, in describing one of the plurality of foil support surfaces 420 in another non-limiting example. In some embodiments, a UV-based curing system, shown in the form of UV lights 510, are mounted relative to stack table 402 along the second axis. In some embodiments, an amount of ultraviolet-curable gluing reagent 208 is applied to foil support surface 420. In some embodiments, an amount of ultraviolet-curable gluing reagent 208 is applied across the second axis to the pre-folded edge 504. In some embodiments, additional ultraviolet-curable gluing reagent 208 may also (or instead) be applied along the second axis to folded edge 502. In a manner similar to that discussed previously herein, the UV lights 510 can be selectively activated to cure the amount of ultraviolet-curable gluing reagent 208 applied across the second axis to the pre-folded edge 504 and/or the folded edge 502 to bond the series of electrode folds 206 to create a consolidated battery stack 200 (refer to FIG. 2).

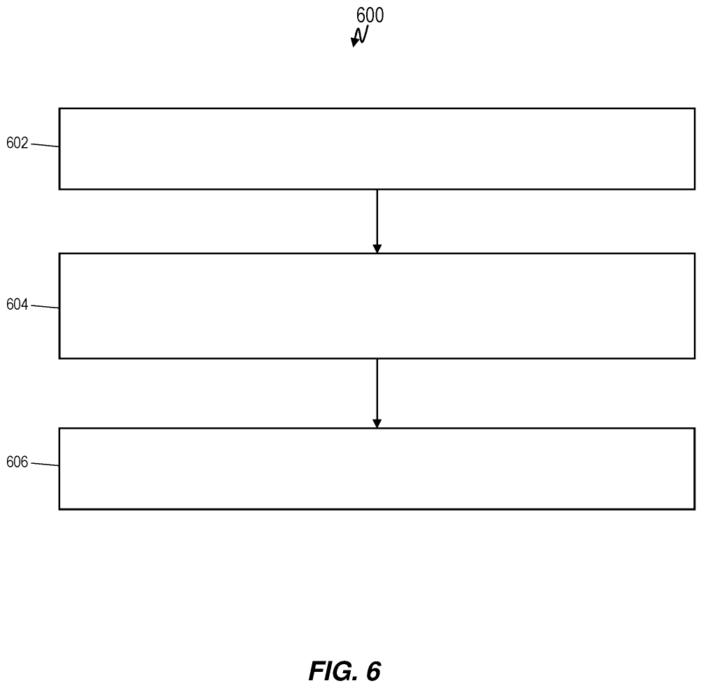

Referring now to FIG. 6, a flowchart 600 for leveraging an ultraviolet-curable gluing reagent for electrode stacking is generally shown according to an embodiment. The flowchart 600 is described in reference to FIGS. 1-5B and may include additional steps not depicted in FIG. 6. Although depicted in a particular order, the blocks depicted in FIG. 6 can be rearranged, subdivided, and/or combined.

At block 602, the method includes forming an electrode stack having a plurality of battery foils separated by an insulated member in a stacked configuration that includes an alternating battery foil and insulated member layers.

In some embodiments, the stacked configuration includes a z-fold stacked configuration having two or more electrode folds.

At block 604, the method includes applying an ultraviolet-curable gluing reagent between the alternating battery foil and insulated member layers. The ultraviolet-curable gluing reagent includes a multifunctional acrylate crosslinking agent and an initiator.

In some embodiments, the multifunctional acrylate crosslinking agent includes a multi-dented alkyl acrylate. In some embodiments, the multifunctional acrylate crosslinking agent includes a multibranched alkyl acrylate having N branches, wherein N is 1, 2, 3, or 4. In some embodiments, the multifunctional acrylate crosslinking agent includes at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

In some embodiments, the ultraviolet-curable gluing reagent includes the multifunctional acrylate crosslinking agent and the initiator at an initiator-to-monomer weight ratio of 0.05 weight percent to 10 weight percent.

In some embodiments, the initiator includes a photoinitiator including at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

At block 606, the method includes curing the ultraviolet-curable gluing reagent by exposing the ultraviolet-curable gluing reagent to an ultraviolet light source, thereby fixing the plurality of battery foils to the insulated member in the electrode stack.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell comprising an electrode stack;
wherein the electrode stack of each battery cell comprises a plurality of battery foils separated by an insulated member in a stacked configuration comprising an alternating battery foil and insulated member layers;
wherein the electrode stack of each battery cell further comprises an ultraviolet-curable gluing reagent, the ultraviolet-curable gluing reagent applied between the alternating battery foil and insulated member layers, thereby gluing the plurality of battery foils to the insulated member; and
wherein the ultraviolet-curable gluing reagent comprises a multifunctional acrylate crosslinking agent and an initiator.

2. The vehicle of claim 1, wherein the multifunctional acrylate crosslinking agent comprises a multi-dented alkyl acrylate.

3. The vehicle of claim 1, wherein the multifunctional acrylate crosslinking agent comprises a multibranched alkyl acrylate having N branches, wherein N is 1, 2, 3, or 4.

4. The vehicle of claim 3, wherein the multifunctional acrylate crosslinking agent comprises at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

5. The vehicle of claim 1, wherein the initiator comprises a photoinitiator comprising at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

6. The vehicle of claim 1, wherein the stacked configuration comprises a z-fold stacked configuration having two or more electrode folds.

7. The vehicle of claim 1, wherein the ultraviolet-curable gluing reagent is cured using an ultraviolent light source, thereby fixing the electrode stack.

8. An ultraviolet-curable gluing reagent comprising:
a multifunctional acrylate crosslinking agent comprising a multi-dented alkyl acrylate, the multi-dented alkyl acrylate comprising a multibranched alkyl acrylate having N branches, wherein N is 1, 2, 3, or 4; and
an initiator at an initiator-to-monomer weight ratio of 0.05 weight percent to 10 weight percent.

9. The ultraviolet-curable gluing reagent of claim 8, wherein the multifunctional acrylate crosslinking agent comprises at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

10. The ultraviolet-curable gluing reagent of claim 8, wherein the initiator comprises a photoinitiator comprising at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

11. The ultraviolet-curable gluing reagent of claim 8, further comprising a binding additive.

12. The ultraviolet-curable gluing reagent of claim 11, wherein the binding additive comprises a polymer having an unsaturated structure.

13. The ultraviolet-curable gluing reagent of claim 11, wherein the binding additive comprises at least one of styrene butadiene (SBR) and silicone.

14. A manufacturing process for stacking electrodes, the process comprising:
forming an electrode stack comprising a plurality of battery foils separated by an insulated member in a stacked configuration comprising an alternating battery foil and insulated member layers,
applying an ultraviolet-curable gluing reagent between the alternating battery foil and insulated member layers, the ultraviolet-curable gluing reagent comprising a multifunctional acrylate crosslinking agent and an initiator; and
curing the ultraviolet-curable gluing reagent by exposing the ultraviolet-curable gluing reagent to an ultraviolet light source, thereby fixing the plurality of battery foils to the insulated member in the electrode stack.

15. The process of claim 14, wherein the multifunctional acrylate crosslinking agent comprises a multi-dented alkyl acrylate.

16. The process of claim 14, wherein the multifunctional acrylate crosslinking agent comprises a multibranched alkyl acrylate having N branches, wherein N is 1, 2, 3, or 4.

17. The process of claim 16, wherein the multifunctional acrylate crosslinking agent comprises at least one of a single branch ethyl acrylate, a single branch methyl acrylate, a double branch diethyl acrylate, a double branch dimethyl acrylate, a triple branch triethyl acrylate, a triple branch trimethyl acrylate, a quadruple branch tetraethyl acrylate, a quadruple branch tetramethyl acrylate.

18. The process of claim 14, wherein the initiator comprises a photoinitiator comprising at least one of a peroxide, benzoyl peroxide (BPO), tertbutyl peroxide, an azo compound, azobisisobutyronitrile, a phosphine oxide, 2,4,6-trimethylbenzoyldiphenylphosphine oxide, methyl benzoylformate, benzophenone, and thioxanthone.

19. The process of claim 14, wherein the stacked configuration comprises a z-fold stacked configuration having two or more electrode folds.

20. The process of claim 14, wherein the ultraviolet-curable gluing reagent comprises the multifunctional acrylate crosslinking agent and the initiator at an initiator-to-monomer weight ratio of 0.05 weight percent to 10 weight percent.
